(19) United States
(12) Patent Application Publication
(10) Pub. No.: US 2021/0293448 A1
(43) Pub. Date: Sep. 23, 2021

(54) HVAC SYSTEM INCLUDING SOUND WAVE GENERATOR

(71) Applicant: DENSO International America, Inc., Southfield, MI (US)

(72) Inventors: Alex ROTHENHAUSER, Redford, MI (US); Prakash THAWANI, Bloomfield Hills, MI (US)

(21) Appl. No.: 16/825,601

(22) Filed: Mar. 20, 2020

(51) Int. Cl. F24F 13/24; F24F 5/00

(52) U.S. Cl. CPC F24F 13/24; F24F 2013/247; F24F 5/001

(57) ABSTRACT

A heating, ventilation, and air conditioning (HVAC) system including a refrigerant line configured to carry refrigerant. A sound wave generator is in cooperation with the refrigerant line to introduce sound waves into the refrigerant line. The sound waves are configured to break up bubbles in the refrigerant within the refrigerant line to suppress noise resulting from the bubbles flowing through the HVAC system

### FIELD

The present disclosure relates to a heating, ventilation, and air conditioning (HVAC) system including a sound wave generator for breaking up refrigerant gas bubbles to suppress hiss and gurgle noises.

### BACKGROUND

This section provides background information related to the present disclosure, which is not necessarily prior art.

Heating, Ventilation, and Air Conditioning (HVAC) systems sometimes produce unwanted noises under certain conditions. For example, sometimes hiss and/or gurgle noises are generated due to bubbles in gas-liquid refrigerant flowing through the HVAC system. While current HVAC systems are suitable for their intended use, they are subject to improvement. An HVAC system that does not produce such unwanted hiss and gurgle noises would be desirable. The present disclosure advantageously provides for an improved HVAC system that suppresses, or at least reduces the occurrence of, bubbles in refrigerant lines of the HVAC system, thereby eliminating, or at least reducing, the occurrence of undesirable hiss and gurgle noises in the vehicle interior.

### SUMMARY

This section provides a general summary of the disclosure, and is not a comprehensive disclosure of its full scope or all of its features.

The present disclosure provides for a heating, ventilation, and air conditioning (HVAC) system. The HVAC system includes a refrigerant line configured to carry refrigerant. A sound wave generator is in cooperation with the refrigerant line to introduce sound waves into the refrigerant line. The sound waves are configured to break up bubbles in the refrigerant within the refrigerant line to impede propagation of the bubbles and suppress noise resulting from the bubbles flowing through the HVAC system.

The present disclosure further includes a heating, ventilation, and air conditioning (HVAC) system including an evaporator, an expansion valve, a first refrigerant line extending from the expansion valve to the evaporator, and a second refrigerant line extending from the evaporator to the expansion valve. A sound wave generator is in cooperation with one of the first refrigerant line and the second refrigerant line to introduce sound waves into one of the first refrigerant line and the second refrigerant line. The sound waves are configured to break up refrigerant bubbles to reduce noise resulting from the refrigerant bubbles flowing through the HVAC system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an exemplary heating, ventilation, and air conditioning (HVAC) system including a sound wave generator in accordance with the present disclosure;

FIG. 2 is an exemplary sound wave generator of the HVAC system of FIG. 1 in accordance with the present disclosure; and

FIG. 3 illustrates area 3 of FIG. 2.

Corresponding reference numerals indicate corresponding parts throughout the several views of the drawings.

### DETAILED DESCRIPTION

Example embodiments will now be described more fully with reference to the accompanying drawings.

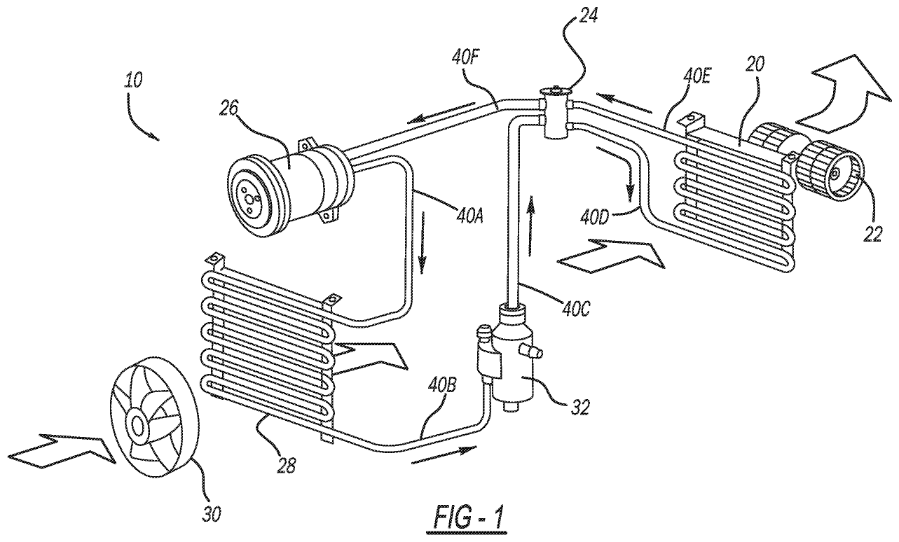

FIG. 1 illustrates an exemplary heating, ventilation, and air conditioning (HVAC) system in accordance with the present disclosure. The HVAC system may be configured for use with any suitable vehicle, such as any suitable passenger vehicle, mass transit vehicle, utility vehicle, military vehicle/equipment, construction vehicle/equipment, watercraft, aircraft, etc. The HVAC system 10 may also be configured for any suitable non-vehicular use as well. For example, the HVAC system 10 may be configured for heating and cooling any suitable building or other structure.

In the example of FIG. 1, the HVAC system 10 includes an evaporator 20 and a blower 22. The HVAC system 10 further includes an expansion valve 24, a compressor 26, a condenser 28, a fan 30 for circulating airflow across the condenser 28, and a drier 32. The HVAC system 10 includes various refrigerant lines for circulating any suitable refrigerant throughout the HVAC system 10. The refrigerant lines may be any suitable conduits for circulating refrigerant, such as, but not limited to hard piping (such as steel, copper, or aluminum piping, for example) or composite rubber hoses. The refrigerant may be any suitable refrigerant, such as R-134A, HF0-1234yf, CO₂, etc.

Refrigerant line 40A connects the compressor 26 to the condenser 28. High pressure gas refrigerant flows from the compressor 26 to the condenser 28. As the refrigerant flows through the condenser 28, the refrigerant cools and condenses into high pressure liquid refrigerant. The high pressure liquid refrigerant flows through refrigerant line 40B, which connects the condenser 28 to the drier 32. Refrigerant line 40C connects the drier 32 to the expansion valve 24. Refrigerant enters the expansion valve 24 as a high pressure liquid, and exits the expansion valve 24 as a cold, low pressure gas and liquid. The cold, low pressure gas and liquid flows from the expansion valve 24 to the evaporator 20 through refrigerant line 40D. The expansion valve may be any suitable expansion valve such as, but not limited to, the following: a thermal expansion valve (TXV), automatic expansion valve (AXV), electronic expansion valve, (EXV), capillary tube, orifice, etc.

The refrigerant absorbs heat as it flows through the evaporator 20, thereby cooling airflow blown across the evaporator 20 by the blower 22. Refrigerant leaves the evaporator 20 as a low pressure gas, and flows back to the expansion valve 24 through refrigerant line 40E. Refrigerant line 40F connects the expansion valve 24 to the compressor 26. Refrigerant bubbles may be present in any of the refrigerant lines 40A-F. In particular, undesirable refrigerant gas bubbles may be present in the refrigerant lines 40D and/or 40E connecting the evaporator 20 to the expansion valve 24, which often produce refrigerant flow induced hiss and gurgle. This hiss and gurgle, if not suppressed, often gets amplified and radiated from the evaporator 20 into the vehicle interior.

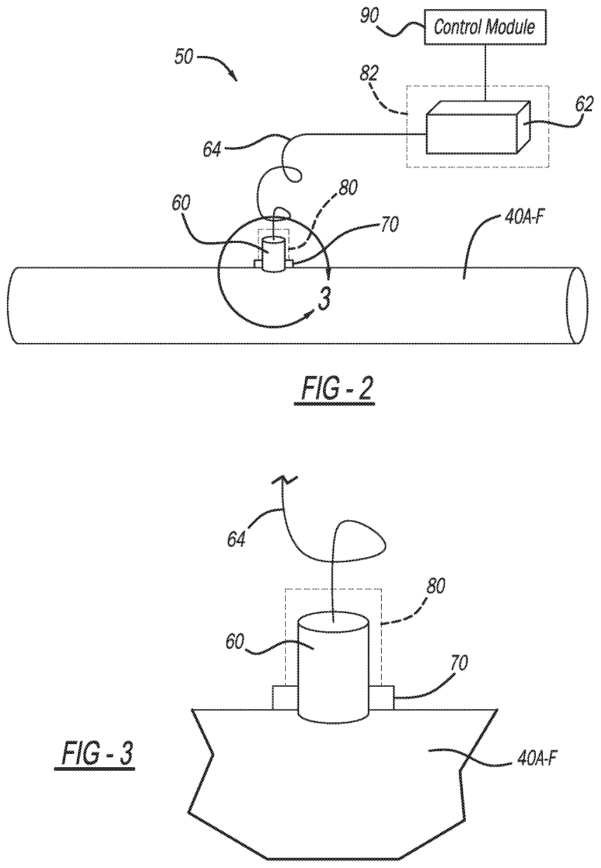

With continued reference to FIG. 1 and additional reference to FIG. 2, the HVAC system 10 includes a sound wave generator 50. The sound wave generator 50 is configured to generate sound waves of any type and frequency suitable for breaking up refrigerant bubbles, such as ultrasonic sound waves, sonic sound waves, etc. The sound wave generator 50 may be placed in cooperation with any of the refrigerant lines 40A-40F to introduce sound waves into refrigerant running through the refrigerant lines 40A-40F to break up bubbles in the refrigerant. Breaking up the refrigerant bubbles advantageously reduces undesirable noises, such as hiss and/or gurgle, which often result from refrigerant flowing through the refrigerant lines 40D and/or 40E. The HVAC system 10 may include one sound wave generator 50 or multiple sound wave generators 50 connected to different refrigerant lines 40A-40F for introducing sound waves into one or more of the refrigerant lines 40A-40F. For example, the refrigerant line 40D may include the sound wave generator 50, the refrigerant line 40E may include the sound wave generator 50, or both refrigerant lines 40D and 40E may include the sound wave generator 50.

The sound wave generator 50 includes a transducer 60 and a transducer receiver 62. The transducer 60 generates sound waves by converting electrical energy into sound. The transducer 60 is connected to the transducer receiver 62 by a transducer signal wire 64. The transducer 60 and the transducer receiver 62 may be any suitable transducer and transducer receiver configured to generate sound waves and introduce the sound waves to the refrigerant lines 40A-40F to break up bubbles going into the evaporator 20. For example, the sound waves may be ultrasonic sound waves or sonic sound waves of any suitable frequency.

With reference to FIGS. 2 and 3, the transducer 60 may be placed in cooperation with any of the refrigerant lines 40A-40F in any suitable manner. For example, the transducer 60 may be mounted to an exterior of any of the refrigerant lines 40A-40F with any suitable coupling 70, such as any suitable adhesive, weld, fastener (nut and screw, for example), seat, clamp, etc. The refrigerant line 40A-40F to which the transducer 60 is mounted may define an opening, and the transducer 60 may be mounted at or in the opening. The transducer 60 may be mounted in the opening flush with an interior surface of the refrigerant line 40A-40F so that the transducer does not disrupt refrigerant flow.

The transducer 60 may include any suitable shield 80. Likewise, the transducer receiver 62 may include any suitable shield 82. The shields 80, 82 may be any suitable barriers to protect the transducer 60 and the transducer receiver 62 from electrical interference, such as interference generated by the blower 22 and any other electrical components of a vehicle, such as, but not limited, battery packs, an electrical compressor, etc. The shields 80, 82 may also be configured to protect the transducer 60 and the transducer receiver 62 from water, salt, excessive heat, etc.

The HVAC system 10 further includes a control module 90. In this application, including the definitions below, the term “control module” may be replaced with the term “circuit.” The term “control module” may refer to, be part of, or include processor hardware (shared, dedicated, or group) that executes code and memory hardware (shared, dedicated, or group) that stores code executed by the processor hardware. The code is configured to provide the features of the control module 90, the HVAC system 10, and the sound wave generator 50 described herein. The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The control module 90 receives inputs from sensors of the HVAC system 10 regarding the operational status of the HVAC system 10. Exemplary inputs include, but are not limited to, temperature of refrigerant at various locations about the HVAC system 10, speed of the compressor 26, position of the expansion valve 24 (such as whether the expansion valve is open, partially closed, or fully closed), or any other suitable inputs that may be used to determine whether or not bubbles are present in the refrigerant system. If based on the inputs to the control module 90 there is a likelihood of bubbles within the refrigerant, the control module 90 is configured to activate the sound wave generator 50 to introduce sound waves into one or more of the refrigerant lines 40A-40F.

The present disclosure thus advantageously provides for the sound wave generator 50 configured to introduce sound waves into one or more of the refrigerant lines 40A-40F to break up bubbles in refrigerant flowing through the HVAC system 10. Reducing the presence of refrigerant bubbles in the HVAC system 10 advantageously reduces the occurrence of unwanted noises being generated by the HVAC system, such as hiss and/or gurgle noises.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A heating, ventilation, and air conditioning (HVAC) system comprising:
a refrigerant line configured to carry refrigerant; and
a sound wave generator in cooperation with the refrigerant line to introduce sound waves into the refrigerant line, the sound waves configured to break up bubbles in the refrigerant within the refrigerant line to reduce noise resulting from the bubbles flowing through the HVAC system.

2. The HVAC system of claim 1, wherein the refrigerant line connects an evaporator of the HVAC system and an expansion valve of the HVAC system.

3. The HVAC system of claim 2, wherein the refrigerant line carries liquid refrigerant from the expansion valve to the evaporator.

4. The HVAC system of claim 2, wherein the refrigerant line carries gas refrigerant from the evaporator to the expansion valve.

5. The HVAC system of claim 1, wherein the refrigerant line connects an expansion valve of the HVAC system and a compressor of the HVAC system.

6. The HVAC system of claim 1, wherein the refrigerant line connects a compressor of the HVAC system and a condenser of the HVAC system.

7. The HVAC system of claim 1, wherein the refrigerant line connects a condenser of the HVAC system and a drier of the HVAC system.

8. The HVAC system of claim 1, wherein the refrigerant line connects a drier of the HVAC system and an expansion valve of the HVAC system.

9. The HVAC system of claim 1, wherein the sound wave generator is a ultrasonic sound wave generator.

10. The HVAC system of claim 1, wherein the sound wave generator is a sonic generator.

11. The HVAC system of claim 1, wherein the sound wave generator includes a transducer mounted to the refrigerant line.

12. The HVAC system of claim 11, wherein the transducer is mounted to the refrigerant line with at least one of an adhesive, weld, fastener, seat, and clamp.

13. The HVAC system of claim 11, wherein the transducer extends into the refrigerant line.

14. The HVAC system of claim 11, wherein the transducer is mounted to an exterior surface of the refrigerant line and does not extend into the refrigerant line.

15. A heating, ventilation, and air conditioning (HVAC) system comprising:
an evaporator;
an expansion valve;
a first refrigerant line extending from the expansion valve to the evaporator;
a second refrigerant line extending from the evaporator to the expansion valve; and
a sound wave generator in cooperation with one of the first refrigerant line and the second refrigerant line to introduce sound waves into one of the first refrigerant line and the second refrigerant line, the sound waves configured to break up refrigerant bubbles to reduce noise resulting from the refrigerant bubbles flowing through the HVAC system.

16. The HVAC system of claim 15, wherein the sound wave generator is an ultrasonic sound wave generator.

17. The HVAC system of claim 15, wherein the sound wave generator is a sonic generator.

18. The HVAC system of claim 15, wherein the sound wave generator is a first sound wave generator, the HVAC system further comprising a second sound wave generator;
wherein the first sound wave generator is in cooperation with the first refrigerant line to introduce sound waves into the first refrigerant line and the second sound wave generator is in cooperation with the second refrigerant line to introduce sound waves into the second refrigerant line.
